(19) United States
(12) Patent Application Publication
(10) Pub. No.: US 2011/0109745 A1
(43) Pub. Date: May 12, 2011

(54) VEHICLE TRAVELING ENVIRONMENT DETECTION DEVICE

(76) Inventors: Yuzuru Nakatani, Tokyo (JP); Yoshihiko Utsui, Tokyo (JP); Yuichiro Uchigaki, Tokyo (JP)

(21) Appl. No.: 12/995,879

(22) PCT Filed: Jun. 18, 2009
(86) PCT No.: PCT/JP2009/002777

§ 371 Date: Dec. 2, 2010

(30) Foreign Application Priority Data
Jul. 7, 2008 (JP) 2008-176866

(51) Int. Cl. H04N 7/18

(52) U.S. Cl. 348/148; 348/E07.085

(57) ABSTRACT

An image processing device 3 is comprised of an image information acquiring unit 31, a variation calculating unit 32, and an environment detecting unit 34. The image information acquiring unit 31 continuously acquires an image of an object on a lateral side of a vehicle at predetermined sampling time intervals, the image being captured by each of cameras 2a and 2b mounted on the vehicle. The variation calculating unit 32 calculates an image variation from at least two images acquired by the image information acquiring unit 31. The environment detecting unit 34 detects a traveling environment in an area surrounding the vehicle from the image variation calculated by the variation calculating unit 32.

### FIELD OF THE INVENTION

The present invention relates to a vehicle traveling environment detection device that detects a vehicle traveling environment, such as point information about an intersection or a T junction, or vehicle traveling position on a road.

### BACKGROUND OF THE INVENTION

A dead reckoning device used for vehicles and so on can detect the position of a vehicle by using various sensors, such as a speed sensor, a GPS (Global Positioning System) unit, and a gyro sensor. Furthermore, when a certain degree of accuracy is required, a map matching technology of using map information to compare the vehicle position with the map information and correct the vehicle position is used widely.

Because a vehicle position detection method using the above-mentioned dead reckoning device can cause an error between the detected vehicle position and the actual vehicle position, there is a case in which the detected vehicle position deviates from the route based on the map information. Particularly, such an error exerts a large influence upon the detected vehicle position at the time when the vehicle is travelling along a complicated route or in the vicinity of an intersection or a T junction. Therefore, a navigation device mounted in a vehicle needs to correct the vehicle position in order to provide more correct guidance for the user and guide the user more correctly.

By the way, many patent applications about vehicle position correction to such a dead reckoning device as mentioned above have been submitted. For example, a method of extracting features from an image captured by a camera mounted in a vehicle to estimate the current position of the vehicle is known. More specifically, according to the method, a specific object, such as a white line or a road sign, is detected so as to correct the current position of the vehicle (for example, refer to patent reference 1).

### Related Art Document

### Patent Reference

Patent reference 1: JP, 2004-45227,A

### SUMMARY OF THE INVENTION

According to the technology disclosed by above-mentioned patent reference 1, while the vehicle is traveled along a road, the white line at a side end of the road is identified by using an infrared camera. Then, when it is judged that the white line disappears through a fixed road section, it is determined that an intersection exists in the road section, and map matching of the current position to the nearby intersection included in the map information is carried out.

However, as disclosed in patent reference 1, even though the method of detecting a certain specific object so as to correct the current position of the vehicle is used, when the vehicle is traveling in an area where no specific target, such as a white line, exists, any certain specific object cannot be detected. In this case, the vehicle position cannot be corrected.

The present invention is made in order to solve the above-mentioned problem, and it is therefore an object of the present invention to provide a vehicle traveling environment detection device that can detect a vehicle traveling environment, including an intersection, in an area surrounding a vehicle when the vehicle is traveling, independently upon any certain specific object, such as a white line or a road sign.

In order to solve the above-mentioned problem, a vehicle traveling environment detection device in accordance with the present invention includes: an image information acquiring unit for continuously acquiring an image of an object on a lateral side of a vehicle at predetermined sampling time intervals, the image being captured by a camera mounted on the vehicle; a variation calculating unit for calculating a variation of the above-mentioned image from at least two images acquired by the above-mentioned image information acquiring unit; and an environment detecting unit for detecting a traveling environment in an area surrounding the above-mentioned vehicle from the above-mentioned image variation calculated by the above-mentioned variation calculating unit.

The vehicle traveling environment detection device in accordance with the present invention can detect a vehicle traveling environment, including an intersection, in an area surrounding the vehicle when the vehicle is traveling, independently upon any certain specific object, such as a white line or a road sign.

### BRIEF DESCRIPTION OF THE FIGURES

FIG. 1 is a block diagram showing the internal structure of a vehicle traveling environment detection device in accordance with Embodiment 1 of the present invention;

FIG. 2 is a view cited in order to explain the principle of operation of the vehicle traveling environment detection device in accordance with Embodiment 1 of the present invention, and is a schematic diagram showing a state in which a vehicle is approaching an intersection;

FIG. 3 is a view cited in order to explain the principle of operation of the vehicle traveling environment detection device in accordance with Embodiment 1 of the present invention, and show examples of an image captured by a side camera;

FIG. 4 is a view cited in order to explain the principle of operation of the vehicle traveling environment detection device in accordance with Embodiment 1 of the present invention, and is a view showing a graphical representation of a time-varying change in a traveling speed on the image and a time-varying change in the actual speed of the vehicle when the vehicle is passing through an intersection;

FIG. 5 is a flow chart showing the operation of the vehicle traveling environment detection device in accordance with Embodiment 1 of the present invention;

FIG. 6 is a view cited in order to explain the principle of operation of the vehicle traveling environment detection device in accordance with Embodiment 1 of the present invention, and is a schematic diagram showing a state in which the vehicle is traveling along the center of a road, a state in which the vehicle is traveling along a left-hand side of a road, and a state in which the vehicle is traveling along a right-hand side of a road; and

FIG. 7 is a flow chart showing the operation of a vehicle traveling environment detection device in accordance with Embodiment 2 of the present invention.

### EMBODIMENTS OF THE INVENTION

Hereafter, in order to explain this invention in greater detail, the preferred embodiments of the present invention will be described with reference to the accompanying drawings.

### Embodiment 1

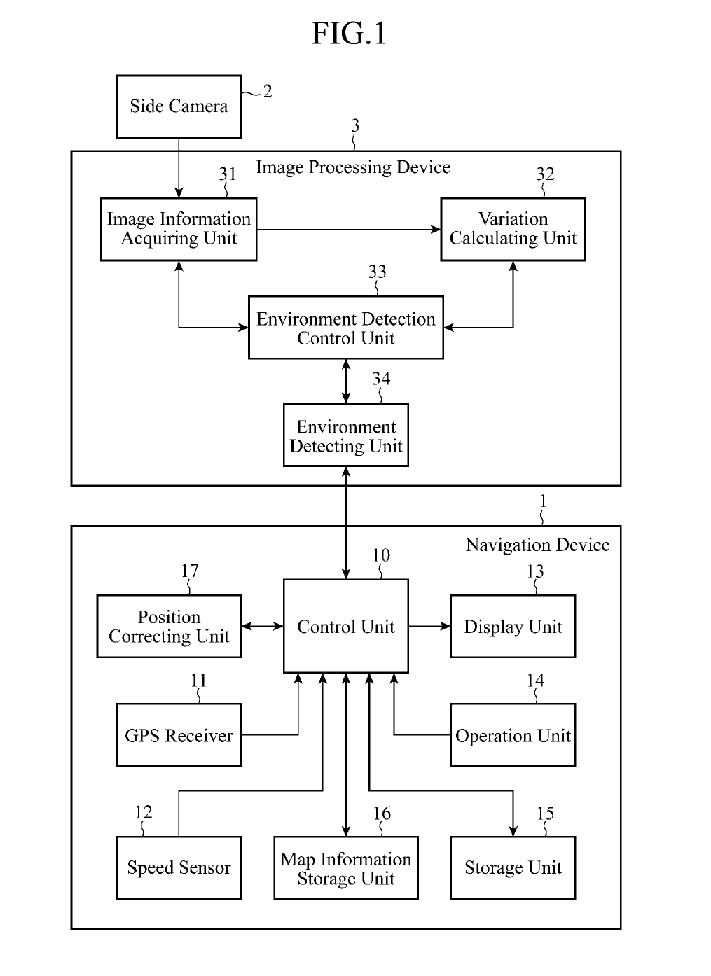

FIG. 1 is a block diagram showing the internal structure of a vehicle traveling environment detection device in accordance with Embodiment 1 of the present invention.

In this embodiment, as the vehicle traveling environment detection device, there is provided a mechanism of using a navigation device 1 mounted in a vehicle, connecting an image processing device 3 to this navigation device 1, and detecting an environment in an area surrounding the vehicle while the vehicle is traveling, independently upon any specific object, by for example, processing an image of a roadside object on a lateral side of the vehicle which is captured by a side camera 2 mounted on a front side surface of the vehicle (e.g., a fender portion). Instead of the side camera 2, an existing surveillance monitor or the like which is already attached to a side face of the vehicle can be used.

As shown in FIG. 1, the navigation device 1 is comprised of a control unit 10 which serves a control center thereof, a GPS receiver 11, a speed sensor 12, a display unit 13, an operation unit 14, a storage unit 15, a map information storage unit 16, and a position correcting unit 17.

The GPS receiver 11 receives signals from not-shown GPS satellites, and outputs information (latitude, longitude, and time) required for measurement of the current position of the vehicle to the control unit 10. The speed sensor 12 detects information (vehicle speed pulses) required for measurement of the speed of the vehicle, and outputs the information to the control unit 10.

The display unit 13 displays information about display of the current position, a destination setting, guidance, and guide, which are generated and outputted by the control unit 10, under control of the control unit 10, and the operation unit 14 receives an operational input made by the user using various switches mounted therein, and transmits the user's instruction to the control unit 10, and also serves as a user interface. Instead of the display unit 13 and the operation unit 14, a display input device, such as an LCD (Liquid Crystal Display Device) touch panel, can be used. Facility information and so on, as well as map information, are stored in the map information storage unit 16.

Various programs which the navigation device 1 uses to implement navigation functions including destination guidance and guide are stored in the storage unit 15, and the control unit 10 reads these programs so as to implement the functions which the navigation device 1 originally has by exchanging information with the GPS receiver 11, the speed sensor 12, the display unit 13, the operation unit 14, the storage unit 15, the map information storage unit 16, and the position correcting unit 17 which are mentioned above.

The position correcting unit 17 has a function of comparing the current position of the vehicle measured by the dead reckoning device including the GPS receiver 11 and the speed sensor 12 with point information about a point, such as an intersection, which is detected by the image processing device 3 which will be mentioned below, and, when the current position of the vehicle differs from the point information, correcting the current position of the vehicle. The details of this function will be mentioned below.

The side camera 2 is an image capturing device for capturing an image of any number of roadside objects on a lateral side of the vehicle while the vehicle is traveling, such as a building in an urban area, a stock farm in a suburb area, a mountain or a river, and the image (a moving image) captured by the side camera 2 is furnished to the image processing device 3.

The image processing device 3 has a function of continuously acquiring the image of the roadside objects on the lateral side of the vehicle which is captured by the side camera 2 mounted on the vehicle at predetermined sampling time intervals to calculate a variation from at least two images acquired and detect an environment in an area surrounding the vehicle while the vehicle is traveling from the calculated image variation, and is comprised of an image information acquiring unit 31, a variation calculating unit 32, an environment detection control unit 33, and an environment detecting unit 34.

The image information acquiring unit 31 continuously acquires an image of roadside objects on a lateral side of the vehicle which is captured by the side camera 2 at the predetermined sampling time intervals, and delivers the captured image to the variation calculating unit 32 and the environment detection control unit 33. The variation calculating unit 32 calculates an image variation from at least two images which are acquired by the image information acquiring unit 31 under sequence control of the environment detection control unit 33, and informs the image variation to the environment detecting unit 34 by way of the environment detection control unit 33.

The variation calculating unit 32 extracts features of the image of a roadside object which is acquired by the image information acquiring unit 31 under sequence control of the environment detection control unit 33, calculates a variation between continuous images on the basis of the features extracted thereby, and informs the variation to the environment detecting unit 34 by way of the environment detection control unit 33. The variation calculating unit 32 further calculates a traveling speed which is a variation per unit time in the features of the roadside object from the image variation and the length of each of the image sampling time intervals, and informs the traveling speed to the environment detecting unit 34 by way of the environment detection control unit 33.

The environment detecting unit 34 detects a traveling environment in an area surrounding the vehicle from the image variation calculated by the variation calculating unit 32 and outputs information about the traveling environment to the control unit 10 of the navigation device 1 under sequence control of the environment detection control unit 33. In this invention, the information about the traveling environment in an area surrounding the vehicle detected by the environment detecting unit 34 can be “point information about a point (i.e., an intersection, a T junction, a railroad crossing, or the like) which is spatially open to the lateral side of the vehicle when seen from the traveling direction of the vehicle”.

The environment detection control unit 33 controls the operating sequence of the image information acquiring unit 31, the variation calculating unit 32, and the environment detecting unit 34, which are mentioned above, in order to enable the image processing device 3 to continuously acquire the image of the roadside objects on the lateral side of the vehicle which is captured by the side camera 2 mounted on the vehicle at the predetermined sampling time intervals to calculate an image variation from at least two images acquired and detect a traveling environment in an area surrounding the vehicle from the calculated variation per unit time of the image.

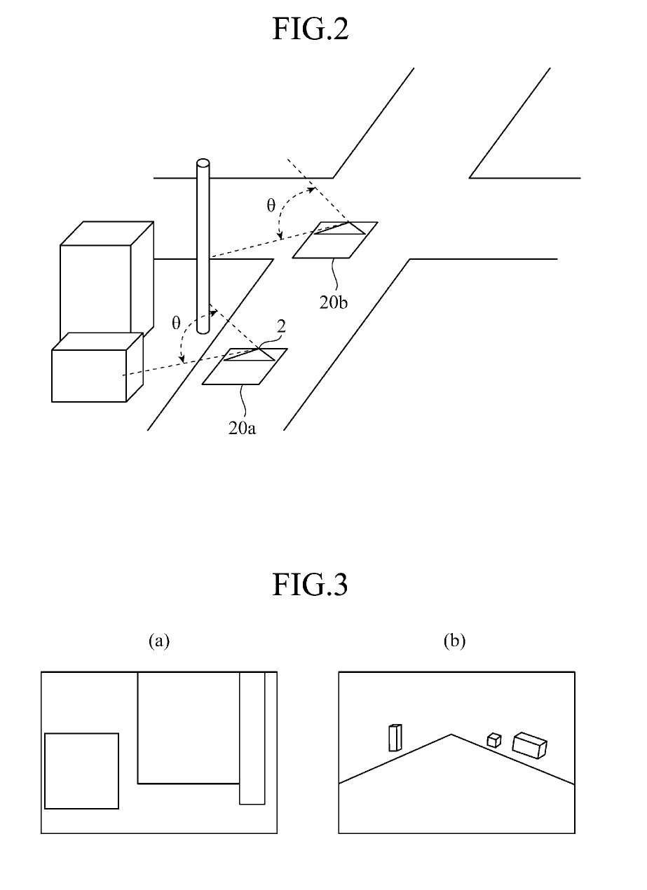

FIG. 2 is a view cited in order to explain the principle of operation of the vehicle traveling environment detection device in accordance with Embodiment 1 of the present invention. In this figure, the roadside objects (a building group) on the lateral side of the vehicle 20a which has not entered an intersection shown in the figure are shown.

In the example shown in FIG. 2, the side camera 2 is attached to the vehicle 20a. The angle of visibility of the side camera 2 in this example is shown by theta, and a region included in the angle of visibility theta is the imaging area of the side camera 2 and this imaging area moves forwardly in the traveling direction of the vehicle with the passage of time. Reference numeral 20b shows the vehicle 20a which has entered the intersection after a certain time has elapsed, and is passing through the intersection.

When the vehicle 20a has moved to the position shown by 20b according to its travel, the vehicle traveling environment detection device in accordance with Embodiment 1 of the present invention calculates either a variation in the image captured by the side camera 2 or a virtual traveling speed of the image which is a variation per unit time of the image through image processing to carry out detection of a point, such as an intersection, a T junction, or a railroad crossing.

FIGS. 3(a) and 3(b) are views cited in order to explain the principle of operation of the vehicle traveling environment detection device in accordance with Embodiment 1 of the present invention. These figures show examples of the image captured by the side camera 2 attached to the vehicle 20a (20b) of FIG. 2.

FIG. 3(a) shows the captured image of the roadside objects on the lateral side of the vehicle before the vehicle has entered the intersection, and FIG. 3(b) shows the captured image of the roadside objects on the lateral side of the vehicle when the vehicle has entered the intersection.

It is clear from a comparison between the images shown in FIGS. 3(a) and 3(b) that the image (FIG. 3(b)) captured in the vicinity of the center of the intersection shows that the forward visibility of the side camera 2 is much better than that in the case of capturing the image (FIG. 3(a)) before the vehicle has entered the intersection, and a roadside object which is far away from the vehicle have been captured as the image. Therefore, it is presumed that the traveling speed of the image captured at the vehicle position 20b is smaller than the traveling speed of the image captured at the vehicle position 20a.

The vehicle traveling environment detection device in accordance with Embodiment 1 of the present invention detects point information about a point including an intersection by using a change of this traveling speed, and further corrects the vehicle position on the basis of the detected point information.

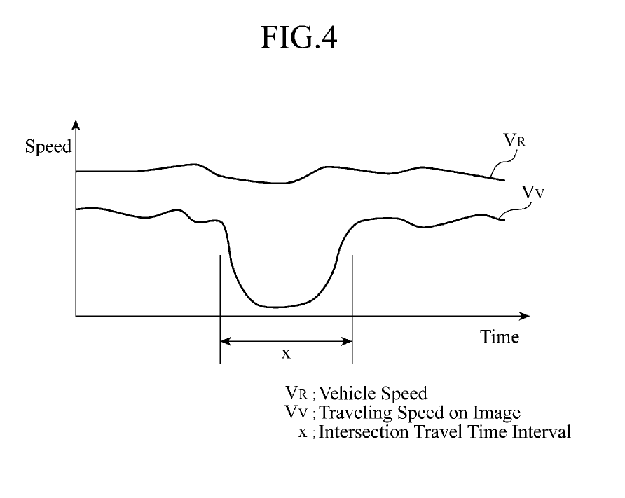

FIG. 4 is a view cited in order to explain the principle of operation of the vehicle traveling environment detection device in accordance with Embodiment 1 of the present invention, and is a graphical representation of a change in the traveling speed of the image at the time when the vehicle 20a has passed through the vehicle position 20b and is passing through the intersection.

In this example, the actual vehicle speed VR which is measured by the speed sensor 12 of the navigation device 1 and the virtual traveling speed VV of the captured image calculated through image processing (by the variation calculating unit 32 of the image processing device 3) are plotted along the time axis and shown. As shown in FIG. 4, it is expected that the virtual traveling speed of the image captured by the side camera 2 in the intersection region through which the vehicle has passed through (during an intersection travel time interval x) is small compared with those of the images captured before and after the vehicle has passed through the intersection.

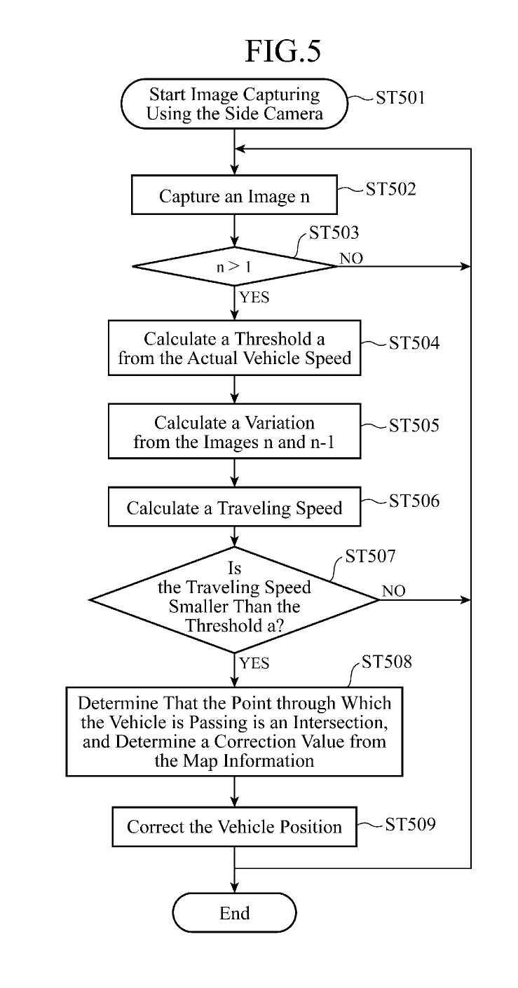

FIG. 5 is a flowchart showing the operation of the vehicle traveling environment detection device in accordance with Embodiment 1 of the present invention. The flow chart shown in FIG. 5 shows a flow of processes of starting the side camera 2, detecting an intersection, and then correcting the vehicle position in detail.

Hereafter, the operation of the vehicle traveling environment detection device in accordance with Embodiment 1 of the present invention shown in FIG. 1 will be explained in detail with reference to the flow chart shown in FIG. 5.

In the flow chart of FIG. 5, image capturing of the objects on the lateral side of the vehicle using the side camera 2 is started first in synchronization with a start of the engine (step ST501). At this time, in the image processing device 3, the image information acquiring unit 31 continuously captures the image of the objects on the lateral side of the vehicle at predetermined sampling time intervals, and furnishes the captured image to the variation calculating unit 32 and the environment detection control unit 33 in time series (n>1) (step ST502, and when “YES” in step ST503).

At this time, the control unit 10 of the navigation device 1 calculates a threshold a used as a criterion by which to determine whether or not the point through which the vehicle is passing is an intersection on the basis of the vehicle speed information measured by the speed sensor 12, and delivers the threshold to the environment detecting unit 34 (step ST504).

Next, the variation calculating unit 32 calculates an image variation between the image n which is captured by the image information acquiring unit 31 and the image n−1 which was captured immediately before the image n is captured (step ST505). At this time, the calculation of the image variation can be carried out by, for example, extracting feature points having steep brightness variations from each of the images, and then calculating the average, the mean square error, or a correlation value of the absolute values of the brightness differences between the sets of pixels of the feature points of the images. The calculation of the image variation is not necessarily based on the above-mentioned method. As long as the difference between the images can be expressed as a numeric value, this numeric value can be handled as the image variation.

The variation calculating unit 32 further calculates a virtual traveling speed of the image which is a variation per unit time of the image from both the image variation calculated in the above-mentioned way, and the frame interval (the sampling time interval) between the images n−1 continuous with respect to time, and informs the virtual traveling speed to the environment detecting unit 34 via the environment detection control unit 33 (step ST506).

Next, when the environment detecting unit determines that the virtual traveling speed of the image calculated by the variation calculating unit 32 is equal to or greater than the threshold a (when “NO” in step ST507), the environment detection control unit 33 determines that the point through which the vehicle is passing is not an intersection, returns to step ST502, and repeats the process of capturing the image. In contrast, when the environment detecting unit determines that the virtual traveling speed of the image calculated by the variation calculating unit 32 is less than the threshold a (when “YES” in step ST507), the environment detection control unit 33 determines that the point through which the vehicle is passing is an intersection, and delivers the determination result to the control unit 10 of the navigation device 1.

Next, the control unit 10 starts the position correcting unit 17 on the basis of the point detection result delivered thereto from the image processing device 3 (the environment detecting unit 34).

When the environment detecting unit 34 determines that the vehicle is passing through an intersection, the position correcting unit 17 compares the point information detected by the environment detecting unit 34 with the current position of the vehicle detected by the dead reckoning device including the GPS receiver 11 and the speed sensor 12. When determining that they differ from each other, the position correcting unit 17 determines a correction value by referring to the map information stored in the map information storage unit 16 (step ST508), corrects the current position of the vehicle according to the correction value determined above, and displays the corrected current position of the vehicle on the display unit 13 via the control unit 10 (step ST509).

In this case, although it is appropriate to determine the threshold a used for point detection on the basis of actual measurement data, it can be expected that the virtual traveling speed of the image at the time when the vehicle is passing through an intersection is reduced to about 60% to 70% of the actual vehicle speed, and this value can be used as the threshold a.

As previously explained, in the vehicle traveling environment detection device in accordance with Embodiment 1 of the present invention, the image processing device 3 continuously acquires an image of an object on a lateral side of the vehicle which is captured by the side camera 2 mounted on the vehicle at predetermined sampling time intervals, calculates an image variation from at least two images acquired as above, and detects point information about a point in an area surrounding the vehicle from the calculated image variation. Therefore, the vehicle traveling environment detection device can detect point information about a point, including an intersection, a T junction, a railroad crossing, or the like, which is spatially open to the lateral side of the vehicle when seen from the traveling direction of the vehicle, independently upon any specific object, such as a white line or a road sign. Furthermore, by correcting the current position of the vehicle on the basis of the detected point information, the vehicle traveling environment detection device can improve the accuracy of map matching and carry out reliable navigation.

Although the above-mentioned vehicle traveling environment detection device in accordance with Embodiment 1 of the present invention detects a point by comparing the virtual traveling speed with a threshold a, the vehicle traveling environment detection device can alternatively use a variation in the captured image of the roadside objects on the lateral side of the vehicle, instead of the traveling speed. In this variant, the same advantages can be provided. Also in this case, the variation is not necessarily an actual variation in the captured image of the roadside objects on the lateral side of the vehicle, like in the case of the traveling speed. The variation can be a variation on the image, a relative value relative to a value at a specific position on the image, or a relative value relative to a variation.

### Embodiment 2

The example in which the vehicle traveling environment detection device in accordance with above-mentioned Embodiment 1 detects point information about a point including an intersection as an environment in an area surrounding the vehicle while the vehicle is traveling is shown above. In contrast, in Embodiment 2 which will be explained hereafter, a vehicle traveling environment detection device has side cameras 2a and 2b mounted on both side surfaces of a vehicle respectively (e.g., on both left-side and right-side fender portions of the vehicle) to simultaneously capture both an image of objects on a left-hand lateral side of the vehicle and an image of objects on a right-hand lateral side of the vehicle, and simultaneously tracks both a variation in the image of the objects on the left-hand lateral side of the vehicle and a variation in the image of the objects on the right-hand lateral side of the vehicle which are captured by the side cameras 2a and 2b respectively.

Also in this case, the variation in the image of the objects on each of the left-hand and right-hand lateral sides of the vehicle becomes small with distance between the object which is captured by the corresponding one of the side cameras 2a and 2b and the vehicle, like in the case of Embodiment 1. By using this fact, the vehicle traveling environment detection device can estimate the traveling position of the vehicle within a road from the difference between the variation in the image of the objects on the left-hand lateral side of the vehicle and the variation in the image of the objects on the right-hand lateral side of the vehicle.

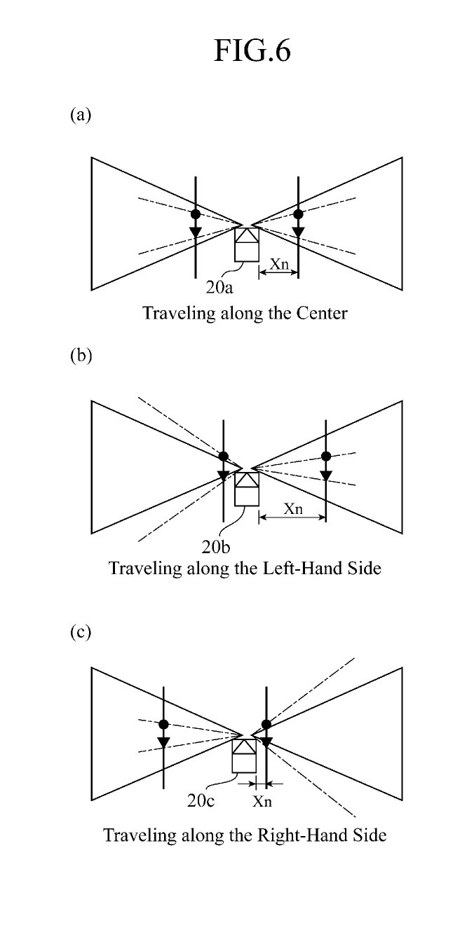

FIGS. 6(a), 6(b), and 6(c) are views cited in order to explain the principle of operation of the vehicle traveling environment detection device in accordance with Embodiment 2 of the present invention.

FIG. 6(a) is a schematic diagram in a case in which the vehicle 20a is traveling along the center of a road. In this case, it is presumed that the difference between the variation in the image of the objects on the left-hand lateral side of the vehicle and the variation in the image of the objects on the right-hand lateral side of the vehicle, the images being captured by the side cameras 2a and 2b respectively. FIG. 6(b) is a schematic diagram in a case in which the vehicle 20b is traveling along the left-hand side of a road. In this case, it is presumed that the variation in the image of the objects on the left-hand lateral side of the vehicle (referred to as the left-hand side variation from here on) is larger than the variation in the image of the objects on the right-hand lateral side of the vehicle (referred to as the right-hand side variation from here on). FIG. 6(c) is a schematic diagram in a case in which the vehicle 20c is traveling along the right-hand side of a road. In this case, it is presumed that the right-hand side variation is larger than the left-hand side variation. It is clear from these presumptions that the vehicle traveling environment detection device can use the estimated vehicle position within a road for vehicle position display and vehicle position correction.

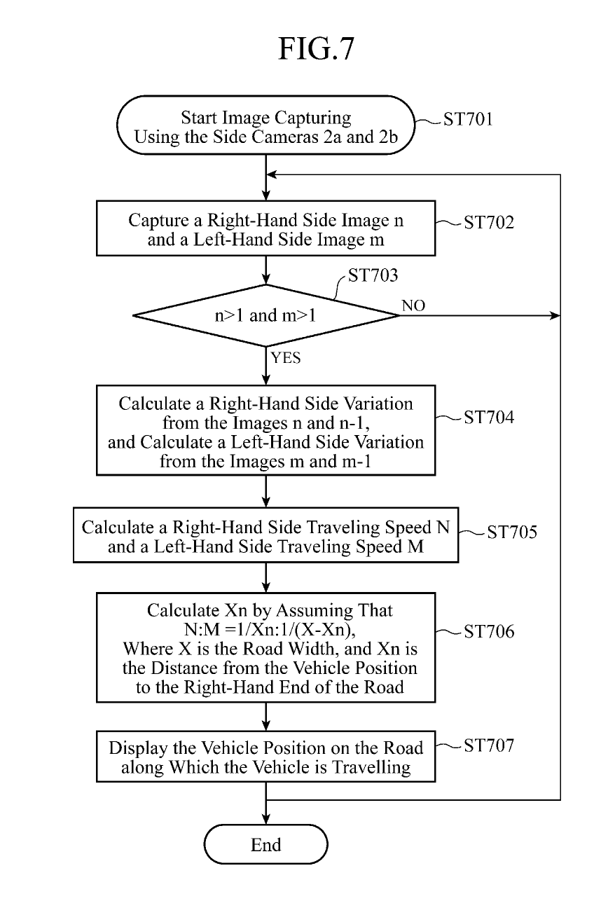

FIG. 7 is a flow chart showing the operation of the vehicle traveling environment detection device in accordance with Embodiment 2 of the present invention. In the flow chart shown in FIG. 7, a flow of processes of starting the side cameras 2a and 2b, detecting the vehicle position within a road, and displaying the vehicle position is shown.

Because the vehicle traveling environment detection device in accordance with Embodiment 2 of the present invention has the same structure as that of Embodiment 1 shown in FIG. 1, with the exception that the side cameras 2a and 2b are mounted on the vehicle, the operation of the vehicle traveling environment detection device in accordance with Embodiment 2 will be explained with reference to the structure shown in FIG. 1.

Image capturing of the objects on each of the left-hand and right-hand lateral sides of the vehicle using the side cameras 2a and 2b is started first in synchronization with a start of the engine (step ST701).

In an image processing device 3, an image information acquiring unit 31 continuously captures the image of the objects on each of the left-hand and right-hand lateral sides of the vehicle at predetermined sampling time intervals and at the same timing, and furnishes the captured image n of the objects on the right-hand lateral side of the vehicle and the captured image m of the objects on the left-hand lateral side of the vehicle to a variation calculating unit 32 and an environment detection control unit 33 in time series (n>1 and m>1) respectively (steps ST702 and ST703).

The variation calculating unit 32 calculates a right-hand side image variation between the image n which is captured by the image information acquiring unit 31 and the image n−1 which was captured immediately before the image n is captured, and also calculates a left-hand side image variation between the image m which is captured by the image information acquiring unit 31 and the image m−1 which was captured immediately before the image m is captured (step ST704).

As long as the difference between the images in the calculation of each of the image variations can be expressed as a numeric value by, for example, calculating the average, the mean square error, or a correlation value of the absolute values of the brightness differences between sets of pixels of feature points of the images, the numeric value can be handled as the image variation, like in the case of calculating the image variation in accordance with Embodiment 1.

The variation calculating unit 32 further calculates a right-hand side traveling speed N and a left-hand side traveling speed M from both these image variations calculated in the above-mentioned way, and the frame interval (the sampling time interval) between the images n (m) and n−1 (m−1) continuous with respect to time, and informs the right-hand side and left-hand side traveling speeds to an environment detecting unit 34 via the environment detection control unit 33 (step ST705).

Next, when calculating the distance Xn from a position where a straight line perpendicular to the traveling direction of the vehicle intersects a side end of the road along which the vehicle is travelling to the position of the right-hand side surface of the vehicle, the environment detecting unit 34 refers to map information stored in a map information storage unit 16 via a control unit 10 of the navigation device 1 so as to acquire information X about the width of the road along which the vehicle is travelling.

Then, assuming that the ratio of the right-hand side traveling speed N to the left-hand side traveling speed M, these traveling speed being calculated by the variation calculating unit 32, is equal to the ratio of the reciprocal of the distance Xn to the roadside on the right-hand side of the vehicle to the reciprocal of the distance X-Xn to the roadside on the left-hand side of the vehicle, the environment detecting unit 34 calculates the distance Xn from the position where a straight line perpendicular to the traveling direction of the vehicle intersects a side end of the road along which the vehicle is travelling to the position of the right-hand side surface of the vehicle, and informs the distance Xn to the control unit 10 of the navigation device 1 (step ST706).

The control unit 10 starts a position correcting unit 17 on the basis of the information (Xn) delivered thereto from the image processing device 3 (the environment detecting unit 34).

On the basis of the traveling position of the vehicle on the road (the distance Xn) which is detected by the environment detecting unit 34, the position correcting unit 17 displays the position of the vehicle during travel which is mapped to the road, the vehicle position including information showing traveling along the center, traveling along the left-hand side, or traveling along the right-hand side in detail on the display unit 13 via the control unit 10 (step ST707).

As previously explained, in the vehicle traveling environment detection device in accordance with Embodiment 2 of the present invention, the image processing device 3 simultaneously and continuously acquires images of objects on left-hand and right-hand sides of the vehicle captured by the side cameras 2a and 2b mounted on the vehicle at predetermined sampling time intervals, calculating a variation of the image of an object on the right-hand side of the vehicle and a variation of the image of an object on the left-hand side of the vehicle from the images acquired above and the images captured immediately before the acquired images, calculates the right-hand side traveling speed and the left-hand side traveling speed from these calculated image variations and the sampling time interval between the images continuous with respect to time, calculates the distance from the position where a straight line perpendicular to the traveling direction of the vehicle intersects a side end of the road along which the vehicle is travelling to the position of the corresponding side surface of the vehicle, and detects and displays the traveling position of the vehicle on the road. Therefore, the accuracy of map matching can be improved and reliable navigation can be carried out.

The vehicle traveling environment detection device in accordance with any one of above-mentioned Embodiments 1 and 2 can be constructed by adding the image processing device 3 to the existing navigation device 1 mounted in the vehicle. The vehicle traveling environment detection device can be alternatively constructed by incorporating the above-mentioned image processing device 3 into the navigation device 1. In this case, although the load on the control unit 10 increases, compact implementation of the vehicle traveling environment detection device can be attained and the reliability of the vehicle traveling environment detection device can be improved.

Furthermore, all the structure of the image processing device 3 shown in FIG. 1 can be implemented via software, or at least part of the structure of the image processing device can be implemented via software.

For example, each of the data processing step of the image information acquiring unit 31 continuously acquiring the image of an object on a side of the vehicle captured by the side camera 2 mounted on the vehicle at predetermined sampling time intervals, the data processing step of the variation calculating unit 32 calculating an image variation from at least two images acquired by the image information acquiring unit 31, and the data processing step of the environment detecting unit 34 detecting a traveling environment in an area surrounding the vehicle from the image variation calculated by the variation calculating unit 32 can be implemented via one or more programs on a computer, or at least part of each of the data processing steps can be implemented via hardware.

### INDUSTRIAL APPLICABILITY

As mentioned above, in order to detect a vehicle traveling environment, including an intersection, in an area surrounding a vehicle when the vehicle is traveling, independently upon any certain specific object, such as a white line or a road sign, the vehicle environment detecting device in accordance with the present invention is constructed in such a way as to include the image information acquiring unit for continuously acquiring an image of objects on a lateral side of the vehicle at predetermined sampling time intervals, the variation calculating unit for calculating a variation in the above-mentioned image from at least two images, and the environment detecting unit for detecting the traveling environment in the area surrounding the vehicle from the variation in the above-mentioned image. Therefore, the vehicle environment detecting device in accordance with the present invention is suitable for use as a vehicle traveling environment detection device that detects a vehicle traveling environment, such as point information about an intersection, a T junction, or the like, or the vehicle traveling position on the road.

1. A vehicle traveling environment detection device comprising:
an image information acquiring unit for continuously acquiring an image of an object on a lateral side of a vehicle at predetermined sampling time intervals, the image being captured by a camera mounted on the vehicle;
a variation calculating unit for extracting, as features, a variation in brightness of said image from at least two images acquired by said image information acquiring unit so as to calculate a variation in said brightness between images continuously acquired on a basis of said extracted features; and
an environment detecting unit for detecting a traveling environment in an area surrounding said vehicle from said image variation calculated by said variation calculating unit.

2. The vehicle traveling environment detection device according to claim 1, wherein said variation calculating unit extracts features of said image of the object on the lateral side of the vehicle which is acquired by said image information acquiring unit, and calculates a variation between images continuously acquired on a basis of said extracted features.

3. The vehicle traveling environment detection device according to claim 2, wherein said variation calculating unit calculates a variation per unit time of said object on the lateral side of the vehicle as a traveling speed of the image from said calculated image variation and said sampling time intervals at which the image is acquired.

4. The vehicle traveling environment detection device according to claim 3, wherein said environment detecting unit detects point information about a point which is spatially open to the lateral side when seen from a traveling direction of said vehicle.

5. The vehicle traveling environment detection device according to claim 4, wherein said environment detecting unit compares the variation of said features or the traveling speed which is calculated by said variation calculating unit with a threshold set for said variation or said traveling speed so as to detect said point information.

6. The vehicle traveling environment detection device according to claim 5, wherein said vehicle traveling environment detection device includes a position correcting unit for comparing the point information detected by said environment detecting unit with a current position of said vehicle detected by a dead reckoning device so as to correct the current position of said vehicle when the point information differs from the current position of said vehicle.

7. The vehicle traveling environment detection device according to claim 1, wherein said environment detecting unit calculates a distance from a position where a straight line perpendicular to a traveling direction of said vehicle intersects a side end of a road along which the vehicle is traveling and a position of a side surface of said vehicle so as to detect a traveling position of said vehicle on the road.

8. The vehicle traveling environment detection device according to claim 7, wherein said image information acquiring unit simultaneously acquires both an image of an object on a left-hand lateral side of said vehicle and an image of an object on a right-hand lateral side of said vehicle by using cameras mounted on said vehicle, said variation calculating unit extracts, as features, a variation in brightness of each of the images of the left-hand side and right-hand side objects acquired by said image information acquiring unit so as to calculate a variation in said brightness between continuous images on a basis of said extracted features, and also calculates a right-hand side traveling speed N and a left-hand side traveling speed M of said features from said calculated variation and the sampling time interval between said continuous images acquired, and, when calculating the distance Xn from the position where the straight line perpendicular to the traveling direction of said vehicle intersects the side end of the road along which the vehicle is traveling and the position of the side surface of said vehicle, said environment detecting unit acquires information X about a width of the road along which the vehicle is traveling with reference to map information, and calculates said Xn by assuming that a ratio of the right-hand side traveling speed N to the left-hand side traveling speed M, these traveling speed being calculated by said variation calculating unit, is equal to a ratio of a reciprocal of the distance Xn to a roadside on a right-hand side of the vehicle to a reciprocal of a distance X-Xn of left-hand side to a roadside on a right-hand side of the vehicle.

9. The vehicle traveling environment detection device according to claim 7, wherein said vehicle traveling environment detection device includes a position correcting unit for outputting a vehicle position of said vehicle to a display unit on a basis of the traveling position of said vehicle on the road detected by said environment detecting unit.
